(19) United States
(12) Patent Application Publication
(10) Pub. No.: US 2014/0083120 A1
(43) Pub. Date: Mar. 27, 2014

(54) RENEWABLE ENERGY-BASED ATMOSPHERIC WATER GENERATOR

(71) Applicants: Elizabeth Nowak, East Aurora, NY (US); Guy Katz, Ashkelon (IL)

(72) Inventors: Elizabeth Nowak, East Aurora, NY (US); Guy Katz, Ashkelon (IL)

(21) Appl. No.: 14/032,652

(22) Filed: Sep. 20, 2013

Related U.S. Application Data
(60) Provisional application No. 61/703,803, filed on Sep. 21, 2012.

(51) Int. Cl. B01D 5/00

(52) U.S. Cl. CPC B01D 5/0006
USPC 62/93; 62/235.1

(57) ABSTRACT

The present invention describes an atmospheric potable water generator apparatus and method of use powered entirely by renewable energy sources, which generates water from atmospheric air. The apparatus uses solar energy to heat atmospheric air in a condensing air chamber, uses wind to cool the air, condenses water on a cooling surface thereby creating potable water from atmospheric air. The apparatus may be used off the energy grid and can be applied on a large scale or for personal portable use.

### RELATED APPLICATIONS

This application claims priority to U.S. Provisional Application No. 61/703,803 filed September 21, 2012. The entire contents of the above application are hereby incorporated by reference as though fully set forth herein.

### FIELD

The present invention relates to the field of water collection, and in particular, to the field of atmospheric water generation. More specifically, the present invention relates to energy-efficient atmospheric water generation devices.

### BACKGROUND

Access to fresh water is central to the health and economic prosperity of a community. The UN estimates that 880 million people around the world do not have access to a regular supply of clean fresh water. As a result, 5,000 children die every day from waterborne diseases, and countless families go without sufficient water for drinking, food-preparation and sanitation. Furthermore, people in water-poor areas spend valuable time collecting and transporting water to their homes—time that could be otherwise spent on work and education.

The issue of inequality in the distribution of fresh water resources is compounded by the problem of over-use. The fresh water resources to which we have access—lakes, rivers, and ground aquifers—are being depleted at an alarming rate. This is a threat to ecosystems, as well as human health, survival, and security everywhere on the planet. Desalination systems attempt to address this issue, but the technology is energy- inefficient and inaccessible to most of the population. There are around 3,100 cubic miles of water in the atmosphere at any given time, yet there have been only limited attempts to utilize this resource. There have been even fewer efforts to gather atmospheric water in such a way that is energy and cost efficient. As described below, the prior art fails to disclose a simple, energy and cost efficient method and apparatus for gathering atmospheric water.

U.S. Pat. No. 4,285,702 issued Aug. 25, 1981 to Helmut et al describes a system whereby air is absorbed, heated and condensed to yield water. The invention includes a sun collector, a series of fans, an absorber bed, and a heat-retaining medium. The apparatus is used in cycles of day and night. However, the present invention is distinguishable from '702 patent in that the present invention functions independent of cycles of day and night.

U.S. Pat. No. 4,433,552 issued Feb. 28, 1984 to Smith describes a method and apparatus for recovering atmospheric moisture based on a wind-driven electrical generator that powers a refrigeration system. The present invention is distinguishable from the '352 patent as it does not require any electricity or refrigeration to function.

U.S. Pat. No. 5,669,221 issued Sep. 23, 1997 to LeBleu et al describes a portable atmospheric water generator based on a resistance-heating strip and fan that warms the air before condensing the water. The present invention is distinguishable from the '221 patent as it uses a solar heating apparatus rather than a resistance-heating strip and fan combination to heat the air before condensing the water.

U.S. Pat. No. 8,196,422 issued Jun. 12, 2012 to Ritchey describes an energy- efficient solar-powered atmospheric water generator that uses a refrigerant solution and heat exchange mechanism. The present invention is distinguishable from the '422 patent in that it does not require a refrigerant solution to cool the air prior to condensing the water.

The present invention is distinguishable from some of the issued patents listed above that address the concept of extracting water from atmospheric air because they rely on on-grid power sources to function. Furthermore, all of the issued patents listed above are dependent on refrigerant coolants and at least two steps of energy conversion, which fundamentally reduces the efficiency of the systems. As such, the present invention seeks to provide a novel apparatus that uses wind and solar energy in a heat exchange process that generates potable water from an atmospheric water source. The apparatus of the present invention is simple, low-cost, and depends only on renewable resources to generate water.

### BRIEF SUMMARY OF THE INVENTION

It is the object of the present invention to address several challenges in previous attempts to generate water from atmospheric air. The present invention is entirely off of the energy grid and requires only one step of energy conversion. Furthermore, it does not depend on a refrigerant solution for cooling purposes. The apparatus can be used on a large scale, or it can be scaled-down to a personal, portable level. Although the present invention does not depend on an artificial power source, a mechanically generated wind source could be used to supplement the apparatus in the absence of natural wind resources.

The present invention is an atmospheric portable water generator apparatus comprising: (a) means to generate a supply of air; (b) at least one solar heating apparatus; (c) at least one condensing air chamber; (d) means to cool said condensing air chamber; (e) at least one cooling surface; (f) water collection basin; and (g) an orifice to release collected water. The present invention is also a method of using that atmospheric portable water generator, the steps comprising (a) collecting a supply of air; (b) heating said air in a condensing air chamber; (c) introducing a supply of cooling air to said condensing air chamber; (d) condensing said air in said condensing air chamber; and (e) collecting the resulting water.

The method and apparatus may further comprise a means to detect and collect wind resources as well as an enclosed liquid chamber that is heated by the solar heating apparatus. The condensing air chamber may be lined with a material suitable for absorbing water to increase efficiency, such materials including but not limited to silicon and superabsorbent polymers. The cooling surface may be lined with a material that increases the electrostatic charge of the cooling surface, thereby increasing condensation. One example of such material is glass with metal filaments passing through it, such that the filaments are charged and aid in water condensation. The cooling surface might also be etched thereby creating a capillary action and increasing the amount of condensed water that is collected.

In one embodiment of the present invention, the solar heating apparatus collects heat from the atmosphere by concentrating the heat produced by sunlight with examples of such solar heating apparatus being well known in the prior art. The supply of air is generated by wind and the air supply is heated in a collecting air chamber and subsequently enters the condensing air chamber. The air supply is cooled in the condensing air chamber by introducing a wind supply through an opening or plurality of openings of the condensing air chamber. The temperature gradient created by heating and then cooling the air supply causes condensation to form. The condensation is collected on at least one cooling surface and drips into the water collection basin located at the bottom of the condensing air chamber. The water is released from the water collection through an orifice located at the bottom of the water collection basin.

In a second embodiment of the present invention, the solar heating apparatus collects heat from the atmosphere by concentrating the heat produced by sunlight with examples of such solar heating apparatus being well known in the prior art. The solar heating apparatus is adjacent to and heats an enclosed chamber that is filled with liquid, such as water. The heated liquid transfers heat to a supply of air flowing through the condensing air chamber. The supply of air is introduced to the condensing air chamber by the use of an air intake fan and the air is subsequently released from the condensing air chamber through an air pressure valve opening positioned on the side opposite the air intake fan. The air supply is cooled in the condensing air chamber by introducing a wind supply through an opening or plurality of openings of the condensing air chamber. The temperature gradient created by heating and then cooling the air supply causes condensation to form. The condensation is collected on at least one cooling surface and drips into the water collection basin located at the bottom of the condensing air chamber. The water is released from the water collection through an orifice located at the bottom of the water collection basin.

### BRIEF DESCRIPTION OF THE DRAWINGS

FIG. 1 is a frontal cross section view of one embodiment of the present invention.

FIG. 2 is a frontal cross section view of a second embodiment of the present invention.

### DETAILED DESCRIPTION

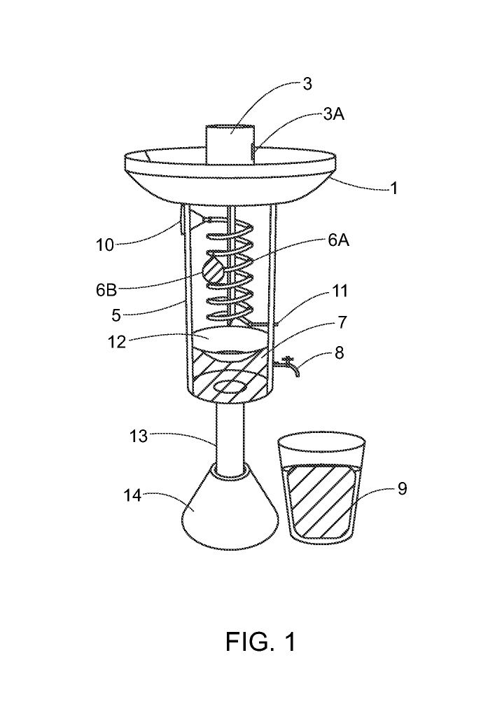

Referring now to the invention in more detail, FIG. 1 shows a frontal cross section of one embodiment of the atmospheric water generator. FIG. 1 demonstrates a condensing air chamber 5, which houses cooling surface 6A, funnel 12 and a water storage basin 7. The condensing chamber could be any number of shapes, including a vertical cylinder, a downward facing dome or any other hollow, downward facing shape. The cooling surface 6A is connected to a wind intake funnel 10, which is even with the exterior surface of the condensing air chamber 5. As shown in FIG. 1, a preferred embodiment is that the cooling surface 6A is a hollow metal or ceramic coil running through the condensing air chamber 5 wherein cool air runs through the coil via wind or windmill. An air collection chamber 3 is connected to an atmospheric air intake opening 3A (which may be covered by an air filter). The air intake opening 3A and condensing air chamber 5 are adjacent and connected to solar heating apparatus 1. The condensing air chamber 5 is also connected to water storage basin 7 that releases water through orifice 8. In the preferred embodiment, the orifice is a spout structure.

Atmospheric air that has been heated by solar heating apparatus 1 enters air collecting chamber 3 through an air intake opening 3A and subsequently moves into condensing air chamber 5. The solar heating apparatus is preferably a reflective disk made out of mirrors or other reflective material, but may generally be represented by any suitable solar heating surface or apparatus that is well known in the prior art. The condensing air chamber 5 can be constructed from a variety of materials, including plastic, metal or wood.

A supply of air passes through a cooling surface 6A through a wind intake funnel 10 open to the exterior of the condensing air chamber 5. As the wind travels from a large cross-sectional area (the funnel 10) to a smaller cross sectional area (the cooling surface 6A) it increases in velocity. The increased velocity allows the passing air to rapidly cool to ambient temperature. This differential in temperatures leads to the condensation of water from air inside the condensing air chamber 5 on cooling surface 6A. The wind at the end of the cooling surface exits outside the condensing air chamber 5 at opening 11 and back into the environment. In the absence of natural wind resources, a separate fan (hand powered or electric) can be attached to the outside of the funnel to function as a wind source (not depicted in the diagram). Once the air in condensing air chamber 5 reaches dew point temperature, it condenses into water shown as 6B. The water exits the condensing air chamber 5 through a funnel 12 at the bottom of the air condensing chamber 5 and enters the water storage basin 7. Water can be extracted from an orifice 8, such as a spigot or a spout, connected to the storage basin 7 and into external storage container 9.

A support column 13 is connected to the bottom of condensing air chamber 5 and the top of the base 14. The support column 13 and base 14 can be constructed from plastic, metal or wood. The condensing air chamber 5 may optionally include a means to detect wind sources, such as a “fin” (not shown) on the exterior of the condensing air chamber combined with a ball bearing (not shown) to allow the support column 13 to rotate freely in base 14. When the wind hits the fin, it rotates the entire apparatus such that air intake opening 3A is towards the direction of the wind in a similar fashion to a weathervane. This maximizes wind resources available and ensures a constant flow of ambient air into air collection chamber 3 and subsequently into condensing air chamber 5.

The condensing air chamber 5 may be lined with a material suitable for absorbing water to increase efficiency, such materials including but not limited to silicon and superabsorbent polymers. The cooling surface 6A may be lined with a material that increases the electrostatic charge of the cooling surface, thereby increasing condensation. The cooling surface 6A might also be etched thereby creating a capillary action and increasing the amount of condensed water that is collected.

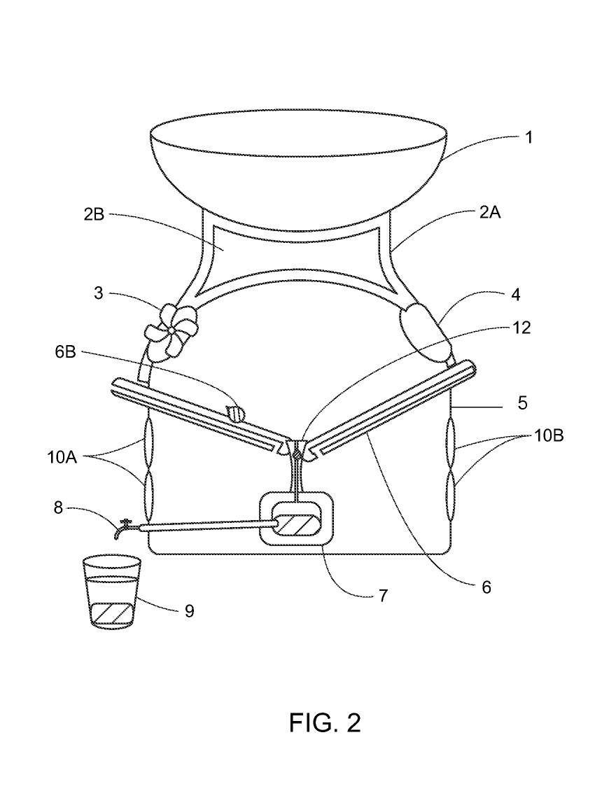

FIG. 2 shows a frontal cross section of a second embodiment of the atmospheric water generator. FIG. 2 demonstrates a condensing air chamber 5, which houses a plurality of cooling surfaces 6A and 6B, funnel 12 and a water storage basin 7. An enclosed chamber 2A is filled with liquid 2B, such as water, and is adjacent and connected to solar heating apparatus 1. The condensing air chamber 5 is adjacent and connected to enclosed chamber 2A and also connected to water storage basin 7 that releases water through orifice 8. In the preferred embodiment, the orifice is a spout structure.

The solar heating apparatus 1 heats the liquid 2B located within enclosed chamber 2A. Atmospheric air enters through air intake fan 3, is heated by transfer of heat from enclosed chamber 2A and is released through exhaust valve 4. The solar heating apparatus is preferably a reflective disk made out of mirrors or other reflective material, but may generally be represented by any suitable solar heating surface or apparatus that is well known in the prior art. The condensing air chamber 5 can be constructed from a variety of materials, including plastic, metal or wood.

A supply of air passes cooling surfaces 6A and 6B by entering through a wind intake opening 10A (or plurality of wind intake openings) and exiting through wind exit opening 10B (or plurality of wind exit openings), both 10A and 10B located on the exterior of the condensing air chamber 5 but below cooling surfaces 6A and 6B. As shown in FIG. 2, the preferred embodiment is cooling surfaces 6A and 6B forming a metal or ceramic double-layered plate within the condensing air chamber 5, such that air runs through the middle of the two layers via wind or windmill. The cooling surfaces 6A and 6B should be angled and positioned for maximum water collection.

The differential in temperatures between hot air inside condensing air chamber 5 and cooling surfaces 6A and 6B leads to the condensation of water from air directly on cooling surfaces 6A and 6B. Once the air in condensing air chamber 5 reaches dew point temperature, it condenses into water shown as 6C. The water exits the condensing air chamber 5 through a funnel 12 at the bottom of the air condensing chamber 5 and enters the water storage basin 7. Water can be extracted from an orifice 8, such as a spigot or a spout, connected to the storage basin 7 and into external storage container 9.

The condensing air chamber 5 may be lined with a material suitable for absorbing water to increase efficiency, such materials including but not limited to silicon and superabsorbent polymers. The cooling surfaces 6A and 6B may be lined with a material that increases the electrostatic charge of the cooling surface, thereby increasing condensation. One example of such material is glass with metal filaments passing through it, such that the filaments are charged and aid in water condensation. The cooling surfaces 6A and 6B might also be etched thereby creating a capillary action and increasing the amount of condensed water that is collected.

The overall purpose of this system is to generate differentials in air temperature in order to reach dew point more readily and therefore generate condensation. Table 1 below demonstrates the air temperatures at which dew point is reached. To illustrate an example, in Beer Sheva, Israel, during the month of September, the relative humidity is 65% (avg), and the temperature is 88° F. (avg). If we heat the ambient air to 120° F., we will be able to cool the system to below dew point (103° F.) using the ambient air (88° F.). If the air inside condensing air chamber 5 is heated via solar reflection, and the air on the cooling surface 6 is rapidly lowered via wind conduction to ambient temperature, then water will effectively condense out.

TABLE 1

| Relative | Ambient air temperature (Fahrenheit) | | | | | | | | | | |
|---|---|---|---|---|---|---|---|---|---|---|---|
| humidity | 20° | 30° | 40° | 50° | 60° | 70° | 80° | 90° | 100° | 110° | 120° |
| 90% | 18 | 28 | 37 | 47 | 57 | 67 | 77 | 87 | 97 | 107 | 117 |
| 85% | 17 | 26 | 36 | 45 | 55 | 65 | 75 | 84 | 95 | 104 | 113 |
| 80% | 16 | 25 | 34 | 44 | 54 | 63 | 73 | 82 | 93 | 102 | 110 |
| 75% | 15 | 24 | 33 | 42 | 52 | 62 | 71 | 80 | 91 | 100 | 108 |
| 70% | 13 | 22 | 31 | 40 | 50 | 60 | 68 | 78 | 88 | 96 | 105 |
| 65% | 12 | 20 | 29 | 38 | 47 | 57 | 66 | 76 | 85 | 93 | 103 |
| 60% | 11 | 19 | 27 | 36 | 45 | 55 | 64 | 73 | 83 | 92 | 101 |
| 55% | 9 | 17 | 25 | 34 | 43 | 53 | 61 | 70 | 80 | 89 | 98 |
| 50% | 6 | 15 | 23 | 31 | 40 | 50 | 59 | 67 | 77 | 86 | 94 |
| 45% | 4 | 13 | 21 | 29 | 37 | 47 | 56 | 64 | 73 | 82 | 91 |
| 40% | 1 | 11 | 18 | 26 | 35 | 43 | 52 | 61 | 69 | 78 | 87 |
| 35% | −2 | 8 | 16 | 23 | 31 | 40 | 48 | 57 | 65 | 74 | 83 |
| 30% | −6 | 4 | 13 | 20 | 28 | 36 | 44 | 52 | 61 | 69 | 77 |

Surface temperature in which condensation occurs

The advantages of the present invention are that it relies solely on renewable resources to function, and it does not require an additional external power source or form of refrigerant solutions. It can be scaled up to a large size, or be made compact for personal (portable) use. The apparatus requires only one form of energy conversion to generate water, ensuring the most energy efficient process. The present invention can be left to function on its own without constant support or supervision, enabling a certain amount of self-sufficiency. The present invention may be scaled up or down, depending on the need of the user. The present invention may also be set up in a series, thereby creating a “water farm.”

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. An atmospheric portable water generator apparatus comprising: (a) means to collect supply of air; (b) at least one solar heating apparatus (c) at least one condensing air chamber; (d) means to cool said condensing air chamber; (e) at least one cooling surface; and (f) water collection basin.

2. The apparatus of claim 1 further comprising an orifice to release water collected in said water collection basin.

3. The apparatus of claim 1 further comprising a means to detect wind resources.

4. The apparatus of claim 1 further comprising an enclosed chamber filled with liquid.

5. The apparatus of claim 4 wherein said enclosed chamber filled with liquid is heated by said solar heating apparatus and wherein said enclosed chamber filled with liquid further transfers heat into said condensing air chamber.

6. The apparatus of claim 1 further comprising at least one lining of said condensing air chamber that is selected from the group comprising silicon, superabsorbent polymers, other material suitable for absorbing water or mixtures thereof.

7. The apparatus of claim 1 further comprising at least one lining of said cooling surface that is a material suitable to increase the electrostatic charge of said cooling surface.

8. The apparatus of claim 1 further comprising at least one lining of said cooling surface that is etched.

9. The apparatus of claim 1 further comprising a collecting air chamber wherein said means to collect a supply of air is an opening to allow wind to flow freely into said collecting air chamber.

10. The apparatus of claim 1 wherein said means to generate supply of air comprises providing a supply of air via an inward sucking fan opening and releasing said supply of air through a pressure valve opening, wherein said inward sucking fan and pressure valve are on opposing sides of said condensing air chamber.

11. The apparatus of claim 1 wherein said condensing air chamber is substantially hollow.

12. The apparatus of claim 1 wherein said condensing air chamber is substantially cylindrical.

13. The apparatus of claim 1 where said cooling surface is in the shape of a substantially hollow coil positioned vertically inside said condensing air chamber.

14. The apparatus of claim 1 wherein further comprising a second cooling surface positioned parallel to said first cooling surface inside said condensing air chamber.

15. A method for generating water from an atmospheric water source comprising: (a) collecting a supply of air; (b) heating said air in a condensing air chamber; (c) introducing a supply of cooling air to said condensing air chamber; (d) condensing said air in said condensing air chamber on a cooling surface; and (e) collecting the resulting water.

16. The method of claim 15 further comprising detecting wind resources.

17. The method of claim 15 further comprising using a solar heating apparatus to heat said supply of air.

18. The method of claim 15 further comprising using a solar heating apparatus to heat at least one enclosed liquid container.

19. The method of claim 15 wherein said cooling surface is etched.

20. The method of claim 15 wherein the surface of said condensing air chamber is lined with a material suitable for absorbing water.
